(19) United States
(12) Patent Application Publication
(10) Pub. No.: US 2026/0014047 A1
(43) Pub. Date: Jan. 15, 2026

(54) STRUCTURE WITH CONDUCTIVE ELASTIC SHEET AND CAPABLE OF AUTOMATICALLY IDENTIFYING INSERTED/PULLED-OUT STATE OF MASSAGE HEAD

(71) Applicant: Zhejiang Red And Black Technology Co.,Ltd, Lishui (CN)

(72) Inventors: Xinyi Shu, Jinyun (CN); Lifeng Shu, Jinyun (CN)

(21) Appl. No.: 18/822,115

(22) Filed: Aug. 31, 2024

(30) Foreign Application Priority Data
Jul. 9, 2024 (CN) 2024216168995

(51) Int. Cl. A61H 23/00

(52) U.S. Cl. CPC A61H 23/006; A61H 2201/0107; A61H 2201/5064

(57) ABSTRACT

A structure with a conductive elastic sheet and capable of automatically identifying an inserted/pulled-out state of a massage head includes a sliding rod structure including a sliding rod support and a sliding cylinder. The sliding rod support is arranged on the sliding cylinder, and mounting grooves with lengths equal to that of the sliding rod support are respectively provided at a left side and a right side of the sliding rod support. The two mounting grooves are provided with a first elastic sheet and a second elastic sheet respectively. When the massage head is fixed to the sliding cylinder and squeezes the first elastic sheet, the first elastic sheet is connected to the second elastic sheet. This application can help implement automatic recognition of the inserted/pulled-out state of the massage head. Once the massage head is pulled out, a removal state of the massage head can be recognized.

### TECHNICAL FIELD

The present disclosure relates to the field of massage devices, and in particular, to a structure with a conductive elastic sheet and capable of automatically identifying an inserted/pulled-out state of a massage head.

### BACKGROUND

In the prior art, a master control program of a massage gun cannot identify whether a massage head is mounted in place, and the massage gun can still be started when the massage head is not mounted in place, resulting in pow consumption. In addition, if the massage gun continues to be used when the massage head is not mounted in place, the massage head may pop up, which may cause personal accidental injury.

### SUMMARY

In view of the above situation, it is necessary to provide a structure with a conductive elastic sheet and capable of automatically identifying an inserted/pulled-out state of a massage head to solve at least one of the above problems. The structure includes a sliding rod structure, which includes a sliding rod support and a sliding cylinder. The sliding rod support is arranged on the sliding cylinder, and mounting grooves with lengths equal to that of the sliding rod support are respectively provided at a left side and a right side of the sliding rod support. The two mounting grooves are provided with a first elastic sheet and a second elastic sheet respectively. When the massage head is fixed to the sliding cylinder and squeezes the first elastic sheet, the first elastic sheet is connected to the second elastic sheet.

Preferably, the first elastic sheet is provided with two protruding contacts, one of the protruding contacts is arranged facing the massage head, and the other protruding contact is arranged facing the first elastic sheet.

Preferably, the sliding rod support is further provided with a fixing groove at a position close to the first elastic sheet, and an end of the first elastic sheet is embedded in the fixing groove.

Preferably, the sliding rod support is provided with an abutting cylinder, and a bent portion of the first elastic sheet is arranged along an edge of the abutting cylinder.

Preferably, the massage head is provided with a contact portion, and the contact portion matches the abutting cylinder in shape and size.

Preferably, the sliding rod support is further provided with a limiting portion, configured to limit a depth of a mounting position between the sliding rod support and the sliding cylinder.

### BRIEF DESCRIPTION OF THE DRAWINGS

1. Sliding rod structure; 11. Sliding rod support; 111. Mounting groove; 12. Sliding cylinder; 13. Fixing groove; 14. Abutting cylinder; 15. Limiting portion; 2. First elastic sheet; 21. Protruding contact; 3. Second elastic sheet; 4. Massage head; 41. Contact portion.

FIG. 1 is a schematic structural diagram showing arrangement of a first elastic sheet and a second elastic sheet on a sliding rod support according to an embodiment of the present disclosure;

FIG. 2 is a schematic structural diagram of a sliding rod support according to an embodiment of the present disclosure;

FIG. 3 is a schematic structural diagram showing connection between a sliding rod structure and a massage head according to an embodiment of the present disclosure; and

FIG. 4 is a schematic structural diagram showing connection and abutment between a sliding rod support and a massage head according to an embodiment of the present disclosure.

### DETAILED DESCRIPTION OF THE EMBODIMENTS

To make the objectives, technical solutions and the advantages of the present disclosure clearer, the structure with a conductive elastic sheet and capable of automatically identifying an inserted/pulled-out state of a massage head according to the present disclosure is described in further detail below with reference to the accompanying drawings and embodiments. It should be understood that specific embodiments described herein are merely intended to explain the present disclosure, but are not intended to limit the present disclosure.

In the description of the present disclosure, unless otherwise specified, “a plurality of” means two or more. The directional or positional relationship indicated by the term such as “central”, “longitudinal”, “transverse”, “upper”, “lower”, “left”, “right”, “inside”, “outside”, “front end”, “rear end”, “head”, “tail”, “vertical”, “horizontal”, “top”, and “bottom” is the directional or positional relationship based on the accompanying drawings, and is merely intended to facilitate and simplify the description of the present disclosure, rather than to indicate or imply that the device or element referred to must have a particular direction and be constructed and operated in a particular direction. Therefore, this should not be construed as limiting the present disclosure. Moreover, the terms “first”, “second”, and “third” are merely used for description, and are not intended to indicate or imply relative importance.

In the description of the present disclosure, it should be noted that, unless otherwise clearly specified, meanings of terms “mount”, “connected with”, and “connected to” should be understood in a board sense. For example, the connection may be a fixed connection, a removable connection, or an integral connection; may be a mechanical connection or an electrical connection; and may be a direct connection or an indirect connection by using an intermediate medium, or may be internal communication between two elements. Those of ordinary skill in the art may understand specific meanings of the above terms in the present disclosure based on a specific situation.

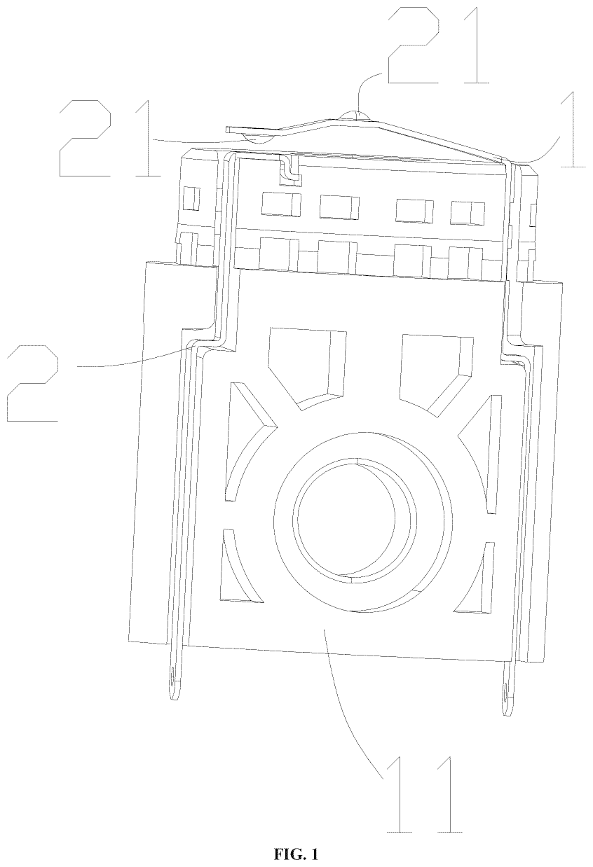

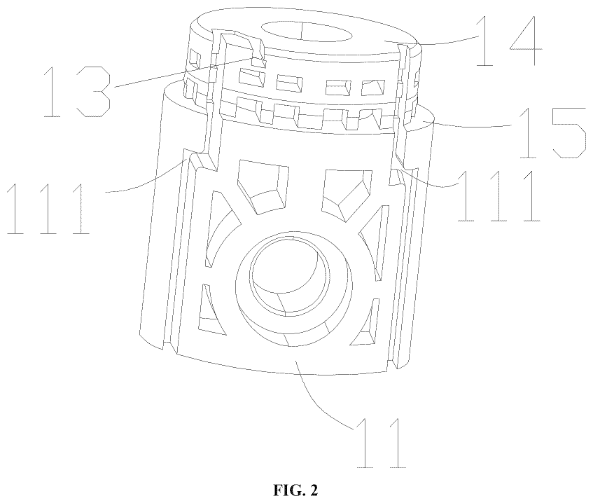

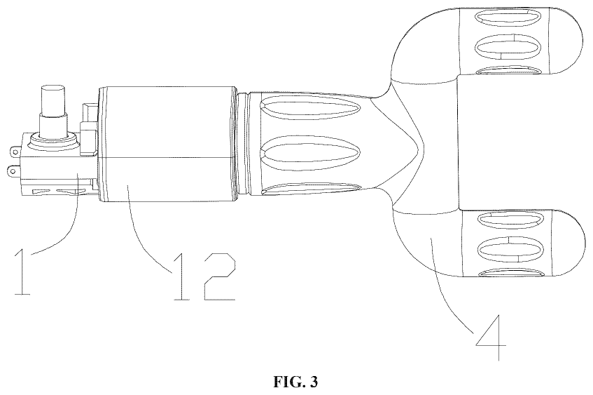

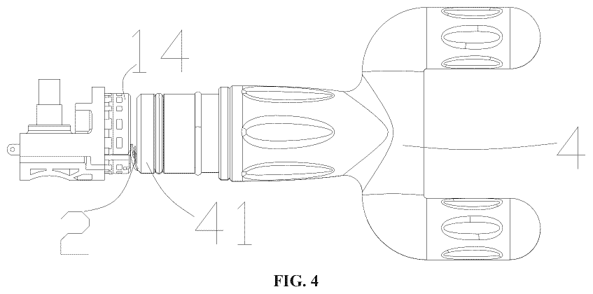

Referring to FIGS. 1 to 4, a structure with a conductive elastic sheet and capable of automatically identifying an inserted/pulled-out state of a massage head 4 according to an embodiment of the present disclosure includes a sliding rod structure 1 including a sliding rod support 11 and a sliding cylinder 12. The sliding rod support 11 is arranged on the sliding cylinder 12, and mounting grooves 111 with lengths equal to that of the sliding rod support are respectively provided at a left side and a right side of the sliding rod support 11. The two mounting grooves are provided with a first elastic sheet 2 and a second elastic sheet 3 respectively. When the massage head 4 is fixed to the sliding cylinder 12 and squeezes the first elastic sheet 2, the first elastic sheet 2 is connected to the second elastic sheet 3.

In the above embodiment, specifically, the structure mainly includes the sliding rod support 11, the sliding cylinder 12, the first elastic sheet 2, the second elastic sheet 3, and the massage head 4. The sliding rod support 11 is firmly arranged on the sliding cylinder 12 as a core for supporting and guiding the sliding cylinder, and the two mounting grooves 111 are equally spaced apart in the left side and the right side of the sliding rod support in a length direction of the support. The two mounting grooves 111 are configured to fix and accommodate the first elastic sheet 2 and the second elastic sheet 3 respectively. The first elastic sheet 2 and the second elastic sheet 3, as key conductive elements, are accurately mounted in the respective mounting grooves 111 to keep a certain interval and elasticity to ensure that the first elastic sheet and the second elastic sheet are in a non-contact state when subjected to no external force, that is, a circuit is disconnected. When the massage head 4 is mounted on the sliding cylinder 12 and is pressed down, a bottom of the massage head 4 comes into contact the first elastic sheet 2, and as being further pressed down, the massage head gradually squeezes a local area of the sliding rod support 11, and then drives the first elastic sheet 2 and the second elastic sheet 3 in the mounting grooves 111 to approach each other. As a spacing between the elastic sheets decreases, when a preset contact point is reached, the first elastic sheet 2 and the second elastic sheet 3 are in physical contact with each other to form a conductive path. Establishment of this conductive path is captured and recognized by a system as an electrical signal, thereby implementing automatic recognition of the inserted/pulled-out state of the massage head 4. Once the massage head 4 is pulled out, the sliding rod support 11 is restored to an original state, the first elastic sheet 2 and the second elastic sheet 3 are separated, the circuit is disconnected, and the system correspondingly recognizes a removal state of the massage head 4.

Referring to FIGS. 1 to 4, the first elastic sheet 2 is provided with two protruding contacts 21, one of the protruding contacts 21 is arranged facing the massage head 4, and the other protruding contact 21 is arranged facing the first elastic sheet 2.

In the above embodiment, one of the protruding contacts 21 faces the massage head 4. This design allows the bottom of the massage head to come into direct or indirect contact with this protruding contact 21 when the massage head 4 is mounted and pressed down, thereby achieving a mechanical squeezing effect. This contact not only ensures the establishment of the conductive path, but also serves as a key signal for identifying that the massage head 4 has been correctly mounted and is in an operating position. The other protruding contact 21 faces the first elastic sheet 2 itself. This design is usually used for fit with the second elastic sheet 3 or another conductive element in the circuit. In the process of pressing down the massage head 4, the overall deformation of the first elastic sheet 2 causes relative displacement between the two protruding contacts 21, and finally makes the two protruding contacts 21 of the first elastic sheet 2 come into effective contact with the second elastic sheet 3 (or a corresponding conductive portion), thus completing closing of the circuit. The design of the double protruding contacts 21 enhances stability and reliability of the conductive path, and ensures accurate recognition of the inserted/pulled-out state of the massage head 4.

Referring to FIGS. 1 to 4, the sliding rod support 11 is further provided with a fixing groove 13 at a position close to the first elastic sheet 2, and an end of the first elastic sheet 2 is embedded in the fixing groove 13.

In the above embodiment, an end of the first elastic sheet 2 is embedded in the fixing groove 13, and stable connection is implemented by physical embedding or other fastening means. This design ensures that when the first elastic sheet 2 is subjected to an external force (for example, the massage head 4 is pressed down), a stable deformation path can be kept based on one end of the first elastic sheet embedded in the fixing groove 13, and the force is effectively conducted to the other end, so that the protruding contacts 21 thereon come into contact with the second elastic sheet 3, thereby establishing the conductive path. This structural principle provides a stable and reliable mechanical support for the automatic recognition of the inserted/pulled-out state of a massage head 4.

Referring to FIGS. 1 to 4, the sliding rod support 11 is provided with an abutting cylinder 15, and a bent portion of the first elastic sheet 2 is arranged along an edge of the abutting cylinder 15.

In the above embodiment, when the first elastic sheet 2 is manufactured, a specific area thereof is bent into a certain shape to be attached to and abut against an outer contour of the abutting cylinder 15. In this design, when the first elastic sheet 2 is subjected to an external force (for example, the massage head 4 is pressed down), the bent portion thereof can move smoothly along the edge of the abutting cylinder 15, thereby controlling a deformation direction and degree of the first elastic sheet. The abutting cylinder 15 not only provides a stable guide for the first elastic sheet 2, but also defines conditions for contact between the first elastic sheet 2 and the second elastic sheet 3 by using a shape and position thereof. When the massage head 4 is pressed down deeply enough, the bent portion of the first elastic sheet 2 is guided by the abutting cylinder 15, so that the protruding contacts 21 thereon can be accurately aligned with and in contact with the second elastic sheet 3, thereby achieving closing of the circuit. On the contrary, when the massage head 4 is pulled out, the first elastic sheet 2 is restored to an original position thereof under the constraint of the abutting cylinder 15, and the protruding contacts 21 are separated from the second elastic sheet 3, so that the circuit is disconnected. This structural principle ensures the accurate recognition of the inserted/pulled-out state of the massage head 4 and the reliable control of closing or opening the circuit.

Referring to FIGS. 1 to 4, the massage head 4 is provided with a contact portion 41, and the contact portion 41 matches the abutting cylinder 15 in shape and size.

In the above embodiment, when the massage head 4 is mounted on the sliding cylinder 12 and pressed down, the contact portion 41 of the massage head 4 abuts against the contacts 21 of the first elastic sheet 2, so that the first elastic sheet 2 is in seamless joint with the second elastic sheet 3 to form a close contact surface, thereby triggering the closing of the circuit.

Referring to FIGS. 1 to 4, the sliding rod support 11 is further provided with a limiting portion, which is configured to limit a depth of a mounting position between the sliding rod support 11 and the sliding cylinder 12.

In the above embodiment, the sliding rod support 11 is additionally equipped with the limiting portion, whose main function is to precisely control a relative mounting position depth between the sliding rod support 11 and the sliding cylinder 12. The limiting portion is usually designed in the form of a protrusion or a groove, which matches a corresponding structure on the sliding cylinder 12 to form a physical barrier. When the sliding rod support 11 is mounted on the sliding cylinder 12, the limiting portion first comes into contact with the corresponding structure on the sliding cylinder 12, thereby preventing the sliding rod support 11 from further moving into the sliding cylinder 12. In this design, it is ensured that the mounting position between the sliding rod support 11 and the sliding cylinder 12 reaches a preset depth, which is neither too tight nor too loose, thereby ensuring stability of the structure, and avoiding mechanical interference or damage that may be caused by too deep mounting.

The above descriptions are only preferred embodiments of the present disclosure, and are not intended to limit the present disclosure in any form. Although the present disclosure has been disclosed by the preferred embodiments above, these embodiments are not intended to limit the present disclosure. Any person skilled in the art may make some changes or modifications to implement equivalent embodiments with equivalent changes by using the technical contents disclosed above without departing from the scope of the technical solution of the present disclosure. Any simple modification and equivalent change made to the foregoing embodiments according to the technical essence of the present disclosure without departing from the content of the technical solution of the present disclosure shall fall within the scope of the technical solution of the present disclosure.

What is claimed is:

1. A structure with a conductive elastic sheet and capable of automatically identifying an inserted/pulled-out state of a massage head, comprising a sliding rod structure comprising a sliding rod support and a sliding cylinder, wherein the sliding rod support is arranged on the sliding cylinder, mounting grooves with lengths equal to that of the sliding rod support are respectively provided at a left side and a right side of the sliding rod support, the two mounting grooves are provided with a first elastic sheet and a second elastic sheet respectively, and when the massage head is fixed to the sliding cylinder and squeezes the first elastic sheet, the first elastic sheet is connected to the second elastic sheet.

2. The structure with a conductive elastic sheet and capable of automatically identifying an inserted/pulled-out state of a massage head according to claim 1, wherein the first elastic sheet is provided with two protruding contacts, one of the protruding contacts is arranged facing the massage head, and the other protruding contact is arranged facing the first elastic sheet.

3. The structure with a conductive elastic sheet and capable of automatically identifying an inserted/pulled-out state of a massage head according to claim 1, wherein the sliding rod support is further provided with a fixing groove at a position close to the first elastic sheet, and an end of the first elastic sheet is embedded in the fixing groove.

4. The structure with a conductive elastic sheet and capable of automatically identifying an inserted/pulled-out state of a massage head according to claim 1, wherein the sliding rod support is provided with an abutting cylinder, and a bent portion of the first elastic sheet is arranged along an edge of the abutting cylinder.

5. The structure with a conductive elastic sheet and capable of automatically identifying an inserted/pulled-out state of a massage head according to claim 4, wherein the massage head is provided with a contact portion, and the contact portion matches the abutting cylinder in shape and size.

6. The structure with a conductive elastic sheet and capable of automatically identifying an inserted/pulled-out state of a massage head according to claim 4, wherein the sliding rod support is further provided with a limiting portion, configured to limit a depth of a mounting position between the sliding rod support and the sliding cylinder.
